(19) United States
(12) Patent Application Publication
(10) Pub. No.: US 2024/0143627 A1
(43) Pub. Date: May 2, 2024

(54) DIRECT RESOURCE SYNC

(71) Applicant: MICRO FOCUS LLC, SANTA CLARA, CA (US)

(72) Inventors: Stephen A. Anderson, Vienna, VA (US); Karl A. Hessinger, Vienna, VA (US); Aparna Chavali Varanasi, Santa Clara, CA (US)

(73) Assignee: MICRO FOCUS LLC, SANTA CLARA, CA (US)

(21) Appl. No.: 17/974,192

(22) Filed: Oct. 26, 2022

(51) Int. Cl. G06F 16/28; G06F 16/11; G06F 16/27

(52) U.S. Cl. CPC G06F 16/283; G06F 16/128; G06F 16/27

(57) ABSTRACT

A snapshot event is received. The snapshot event is a snapshot of data that was sampled based on a snapshot metric. For example, the snapshot event may be a number of user logins (the data) over a specific time period (the snapshot metric). A destination analytical database is determined for the snapshot event. The snapshot event may then be sent to a queue. The snapshot event is then sent to the destination analytical database and stored in the destination analytical database.

### FIELD

The disclosure relates generally to databases and particularly to synchronizing analytical databases.

### BACKGROUND

Relational databases/transactional databases work differently than analytical databases. Analytical databases are not designed to work with relational data that is constantly being updated at a high rate of change. On the other hand, relational databases are more efficient when the data is very dynamic.

### SUMMARY

These and other needs are addressed by the various embodiments and configurations of the present disclosure. The present disclosure can provide a number of advantages depending on the particular configuration. These and other advantages will be apparent from the disclosure contained herein.

A snapshot event is received. The snapshot event is a snapshot of data that was sampled based on a snapshot metric. For example, the snapshot event may be a number of user logins (the data) over a specific time period (the snapshot metric). A destination analytical database is determined for the snapshot event. The snapshot event may then be sent to a queue. The snapshot event is then sent to the destination analytical database and stored in the destination analytical database.

The phrases “at least one”, “one or more”, “or,” and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate” and “compute,” and variations thereof, as used herein, are used interchangeably, and include any type of methodology, process, mathematical operation, or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram of a first illustrative system for synchronizing an analytical database.

FIG. 2 is a block diagram of second illustrative system for synchronizing an analytical database that has multiple queues.

FIG. 3 is a block diagram of an exemplary queue.

FIG. 4 is a flow diagram of a process for synchronizing an analytical database.

FIG. 5 is a flow diagram of a process for filtering event data.

FIG. 6 is a flow diagram of a process for creating snapshot events.

FIG. 7 is a flow diagram of a process for managing an overloaded queue.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

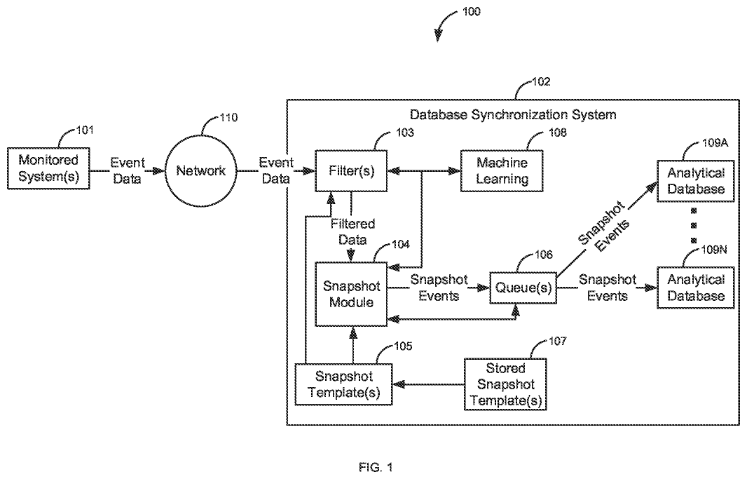

FIG. 1 is a block diagram of a first illustrative system 100 for synchronizing an analytical database 109. The first illustrative system 100 comprises monitored systems 101, a database synchronization system 102, and a network 110.

The monitored system(s) 101 can be any type of devices, such as, server(s), personal computer(s), smartphone(s), router(s), security device(s), embedded device(s), Internet-of-Things (IoT) device(s), sensor(s), printers, virtual machines, containers, manufacturing devices, and/or the like. The monitored system(s) 101 produce event data. Event data may be any type of data associated with monitored system(s) 101, such as security events, action events, user login events, network traffic events, sensor readings, device management events, printing events, access events, CPU usage events, memory events, data access events, thread events, application events, container events, hypervisor events, virtual machine events, and/or the like.

The database synchronization system 102 can be any type of analytical database system that is used to manage the analytical databases 109A-109N. The database synchronization system 102 comprises filter(s) 103, a snapshot module 104, snapshot template(s) 105, queue(s) 106, stored snapshot template(s) 107, machine learning 108, and analytical databases 109A-109N.

The filter(s) 103 can be or may be any process that is used to filter the event data. The filter(s) 103 may filter event data based on the snapshot template(s) 105 and/or the machine learning 108. For example, a user may define filtering of specific types of event data in the snapshot template(s) 105. Alternatively, the machine learning 108 may learn to filter out event data that is irrelevant to the analytical database(s) 109. The filter(s) 103 produce filtered data that is then sent to the snapshot module 104.

The snapshot module 104 can be or may include any hardware coupled with software that can manage snapshot events. Instead of making changes to the analytical database(s) 109 for every event, which is traditionally done in relational/transactional databases, a snapshot is periodically taken of the event data (the filtered data) and the snapshot event(s) are then synchronized to the analytical databases 109A-109N using the queue(s) 106. For example, if the filtered event data changes five times every second, the snapshot event may occur every second versus five times every second in order to reduce the number of events coming into analytical databases 109A-109N. Different snapshot events may have different snapshot periods based on the type of event.

In addition to time-based snapshots, cumulative snapshots may be used. For example, a number of events for a specific event/group of events may be required before a snapshot is taken for a particular event/event type. The events may be a series of events that initiate the snapshot. For example, event A and event B must occur in order to take a snapshot for both events A and B. The cumulative snapshot may also use time as a factor. For example, a snapshot for event A may only be taken if event B occurs within time X after event A occurs. The snapshot event could be used to detect bursts of events (a burst event), lack of events (e.g., a snapshot event is generated if no events occur within a time period), and/or the like. As one would recognize, the options for different event(s)/snapshot event(s)/times can be very diverse.

The snapshot template(s) 105 are templates that define how the snapshot events are generated. The snapshot template(s) 105 may be based on the stored snapshot template(s) 107. The stored snapshot template(s) 107 may be predefined templates, user generated templates and/or the like. The stored snapshot template(s) 107 may be selected by the user to be a snapshot template 105. The snapshot templates 105 may be used by an administrator (i.e., a user) to define snapshot periods/cumulative snapshots. The user may define a set of active lists that are used to monitor specific events. An active list is list of events that the user/administrator defines to track specific events. For example, the active lists of events may be used to identify security issues, such as, failed login attempts, anomalous port usage, anomalous connection activity, network management, Internet-of-Things (IoT) management, manufacturing process management, and/or the like. The snapshots templates 105 may be used to prefilter out unwanted events and can be changed over time. The active lists of events may be stored in the snapshot template(s) 105. The snapshot template(s) 105 may be used based on any type of information that the user is looking to track. The snapshot templates(s) 105 are templates that define the events/data that is being snapshotted and synchronized. The active lists of events may dynamically change based on a state/context of what events are being sampled. For example, if a sequence of events is detected, a different active list may be used to prefilter the event data/define snapshot events.

The queue(s) 106 may be any type of structure/memory that is used to hold the snapshot events before the snapshot events are sent to the analytical databases 109A-109N. The queue(s) 10 may be a single queue 10 or multiple queues 106. The queue(s) 106 may be a First-In-First-Out (FIFO) queue 106. In one embodiment, there may be an individual queue 106 for each analytical database 109A-109N.

The machine learning 108 may be any type of machine learning 108, such as, supervised machine learning, unsupervised machine learning, reinforcement machine learning, semi-supervised machine learning, inductive machine learning, and/or the like. The machine learning 108 may identify specific types of event data to filter based on event data that was previously received. The machine learning 108 may look at all the existing event data (which could be a large number of events) and how each event impacts the analytical database(s) 109 (i.e., the number of events over time) to produce an overall model for the database synchronization system 102. For example, the machine learning 108 may use a clustering algorithm to cluster the event data into groups that can use similar snapshot metrics and/or time-based snapshot periods. To illustrate, consider the following example. Event A may occur more frequently between 8:00 AM and 5:00 PM Monday through Friday (during business hours). Thus, the snapshot period may be shorter during business hours versus nonbusiness hours. In other words, there are two snapshot periods for event A based on the machine learning 108. The learned characteristics for event B may have different characteristics and thus have a different snapshot period(s). The events A/B would likely be in different clusters and classified as different types of snapshot events. This process provides a more accurate view of the data verses a fixed snapshot.

The analytical databases 109A-109N may comprise one or more analytical databases 109. Although not shown in FIG. 1, the analytical databases 109A-109N may reside outside the database synchronization system 102. For example, the analytical databases 109A-109N may reside externally on the network 110. Examples of analytical databases may include the Vertica® database by Micro Focus®.

The network 110 can be or may include any collection of communication equipment that can send and receive electronic communications, such as the Internet, a Wide Area Network (WAN), a Local Area Network (LAN), a packet switched network, a circuit switched network, a cellular network, a combination of these, and the like. The network 110 can use a variety of electronic protocols, such as Ethernet, Internet Protocol (IP), Hyper Text Transfer Protocol (HTTP), Web Real-Time Protocol (Web RTC), and/or the like. Thus, the network 110 is an electronic communication network configured to carry messages via packets and/or circuit switched communications.

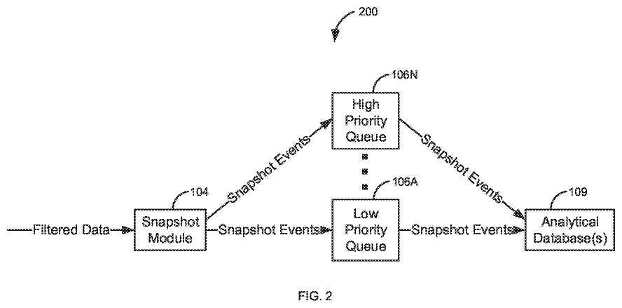

FIG. 2 is a block diagram of second illustrative system 200 for synchronizing an analytical database 109 that has multiple queues 106. In FIG. 2 the snapshot module 104 may send snapshot events to the low priority queue 106A and/or the high priority queue 106N. Although only two queues 106A/106N are shown in FIG. 2, there may be any number of queues 106.

The snapshot module 104 determines which events to send to the queues 106A-106N based on various factors, such as, machine learning 108, based on the snapshot template(s) 105, and/or the like. For example, the snapshot template(s) 105 may define which snapshot events are high/low priority snapshot events. Likewise, the high/low priority snapshot events may be learned over time by the machine learning 108. For example, the machine learning 108 may learn over time, based on user input/analysis, which snapshot events are deemed to be higher/lower priority. The machine learning 108 may use history of the event data to determine, over time, a best snapshot period for each event/event type.

The high priority queue 106N works differently from the low priority queue 106A. For example, the high priority queue 106 may sends the snapshot events to the analytical database(s) 109 based on a shorter time period than the low priority queue 106A. The high priority queue 106N may send more snapshot events to the analytical databases 109 (e.g., 3 to 1) until the high priority queue 106N is empty. The low priority queue 106A will then be fully serviced until the high priority queue 106N receives a new snapshot event. The high priority queue 106N may send more snapshot events based on an availability of the analytical database(s) 109. The analytical database(s) 109 may periodically provide a message that indicates how many snapshot events may be sent by each of the queues 106A-106N. For example, the analytical database 109 may send a message to the high priority queue 106N that it can accept two snapshot events and at the same time the analytical database 109 may send a message to the low priority queue 106A that it can send a single snapshot event.

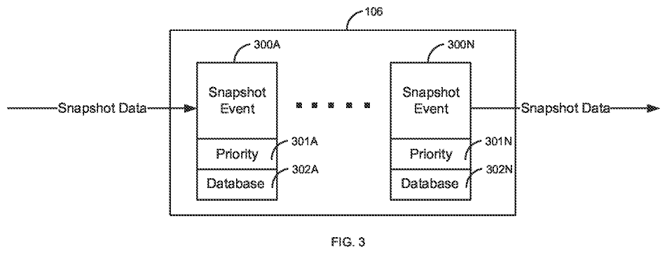

FIG. 3 is a block diagram of an exemplary queue 106. The queue 106 of FIG. 3 is where a single queue 106 is used that can manage snapshot events 300 of different priorities that may be destined to a plurality of analytical databases 109A-109N. The processes described for the queue 106 of FIG. 3 may also work where there are multiple queues 106. For example, the process of FIG. 3 may work where there is queue 106 for each analytical database 109.

When a snapshot event 300 is placed into the queue 106, the snapshot event 300 includes additional fields that may include a priority field 301 and a destination database field 302. For example, the priority field 301 may have two or more different priorities. The destination database field 302 (if used) may indicate the specific analytical database 109 to send the snapshot event 300. The database field 302 may not be part of a snapshot event 300 if there is only a single analytical database 109 being serviced by the queue 106.

In FIG. 3, there are two snapshot events 300A-300N in the queue 106. Although only two snapshot events 300A-300N are shown, any number of snapshot events 300 may be in the queue 106. The snapshot event 300A comprises a priority field 301A and a destination database field 302A. Likewise, the snapshot event 300N comprises a priority field 301N and a destination database field 302N. The queue 106/snapshot module 104 then manages the snapshot events 300A-300N using the priority fields 301A-301N and/or the destination database field 302A-302N.

As the queue 106 becomes more loaded (e.g., meeting a threshold) the queue 106 may identify higher priority snapshot events 300 and prioritize the higher priority snapshot events 300 based on the priority field 301. For example, if the queue 106 becomes 80% full, the snapshot event 300A may be serviced before the snapshot event 300N because the snapshot event 300A has a higher priority.

In addition, the queue 106 may work in conjunction with the snapshot module 104. In this embodiment, the snapshot module 104 may be dynamically adaptive based on feedback from the queue 106. The queue 106 can be monitored by the snapshot module 104 to identify the current status of the queue 106. If a threshold (e.g., an event queue threshold) is met, some or all of the event polling periods for the snapshot events 300 (e.g., an event sample period) may be decreased or increased based on the current loading level of the queue 106. For example, the sample period of one or more of the snapshot events 300 may go from ten seconds to twenty second for a particular snapshot event 300.

Different snapshot events 300 may have priority over other snapshot events 300. For example, if the queue 106 becomes 75% loaded, the snapshot module 104 may change the snapshot period for lower priority snapshot events 300C and 300D's while higher priority snapshot events 300A and 300B snapshot period may stay the same. If the queue 106 becomes 90% loaded, snapshot events 300A and 300B's snapshot period (a snapshot metric) may be increased. Snapshot events 300C and 300D's snapshot period may also be increased a second time (or not) based on defined rules when the threshold is at 90%. Thus, the number of snapshot events 300 that are being placed in the queue 106 is reduced, which will eventually reduce the number of snapshot events 300 in the queue 106. The increase/decrease may vary based on rules/priority. If the queues 106 become full, lower priority snapshot event(s) 300 coming into the queues 106 may be dropped while higher priority snapshot event(s) 300 are maintained.

The event queues size may be dynamically changed based on the number of pending snapshot event(s) 300. For example, during heavily loading periods, the size of the queue 106 may be increased.

The snapshot event(s) 300 may be prioritized based on a tenant and/or a Service Level Agreement (SLA). For example, in a cloud solution, customer A may have higher priority and therefore snapshot event(s) 300 for customer A may have priority over snapshot events 300 for customer B.

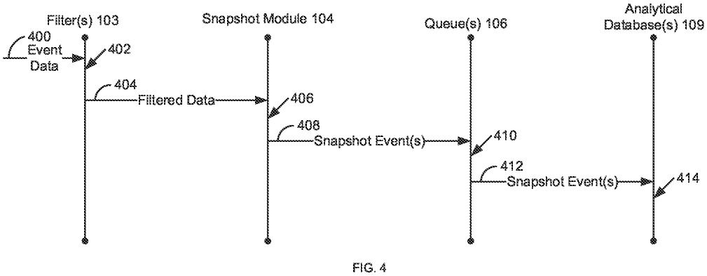

FIG. 4 is a flow diagram of a process for synchronizing an analytical database 109. Illustratively, the monitored system(s) 101, the database synchronization system 102, the filter(s) 103, the snapshot module 104, the queue(s) 106, the machine learning 108, and the analytical database(s) 109 are stored-program-controlled entities, such as a computer or microprocessor, which performs the method of FIGS. 4-7 and the processes described herein by executing program instructions stored in a computer readable storage medium, such as a memory (i.e., a computer memory, a hard disk, and/or the like). Although the methods described in FIGS. 4-7 are shown in a specific order, one of skill in the art would recognize that the steps in FIGS. 4-7 may be implemented in different orders and/or be implemented in a multi-threaded environment. Moreover, various steps may be omitted or added based on implementation.

The process starts in step 400 when the filter(s) 103 receives the event data. The event data may be real-time data, semi-real-time data, and/or stored data. For example, the event data may security information gathered from monitored systems 101 on the network 110.

The filter(s) 103, filter the event data based on the snapshot template(s) 105 and/or the machine learning 108 in step 402. The filtered event data is then sent to the snapshot module 104 in step 404. The snapshot module 104, in step 406, generates the snapshot event(s) 300 based on the snapshot templates 105 and/or machine learning 108. For example, the event data may be a number of login attempts on a server. The snapshot template 105 may define that the number of login attempts is the number of login attempts in a five-minute period. Thus, the generated snapshot event 300 would be the total number of logins in the five-minute period. Second event data may be for a number of database accesses by user over a thirty-minute period. Thus, the generated snapshot event 300 would be the total number of databases accesses by the user over the last thirty-minute period. In addition, other techniques may be used. For example, the event data may be averaged where a composite value is provided (e.g., the five samples are averaged) and the average is provided to the queue 106 to represent the five samples. The snapshot event 300 may be based on meeting a threshold. For example, after there have been five login attempts, where there is a first login time and a last login time.

The snapshot module 104 sends the snapshot event(s) 300 to the queue(s) 106 in step 408. In one embodiment, the snapshot event(s) 300 may be sent directly to the analytical database(s) 109 (i.e., where the queue(s) 106 are not used). The snapshot event(s) 300 are then managed by the queue(s) 106 in step 410. The snapshot event(s) 300 are then sent to the analytical database(s) 109 in step 412. The analytical database(s) 109 then store the snapshot event(s) 300 in step 414.

In one embodiment, only snapshot events 300 are being stored by the analytical databases. In other words, there are no events that are not directly based on the event by itself.

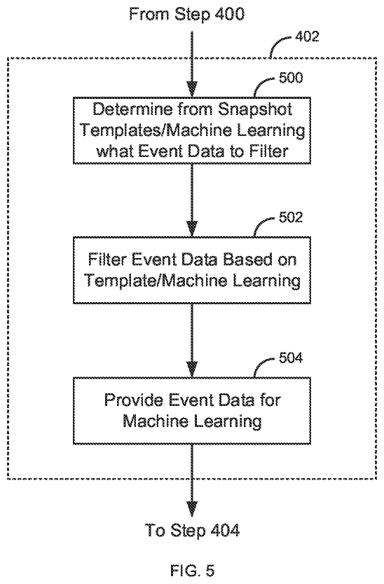

FIG. 5 is a flow diagram of a process for filtering event data. FIG. 5 is an exemplary embodiment of step 402 of FIG. 4. After receiving the event data from the monitored systems 101 in step 400, the filter(s) 103 determines from the snapshot template(s) 105/machine learning 108 what event data to filter 103 in step 500. The event data is then filtered based on the snapshot template(s) 105/machine learning 108 in step 502. The event data is provided to the machine learning 108 in step 504. The event data is used by the machine learning 108 to identify the best time sample periods and/or sample types. For example, the machine learning 108 may identify that the sampling period needs to be much shorter for login attempts that are in the daytime versus those that are on the evenings/weekends. The process then goes to step 404.

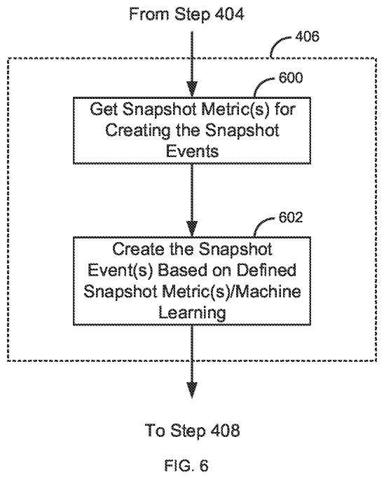

FIG. 6 is a flow diagram of a process for creating snapshot event(s) 300. FIG. 6 is an exemplary embodiment of step 406 of FIG. 4. After receiving the filtered data in step 404, the snapshot module 104 gets the snapshot metric(s) for creating snapshot event(s) 300 in step 600. For example, the snapshot metrics may come from the snapshot template(s) 105/machine learning 108. The snapshot metric(s) may be a time period, an event, a number of events, a specific series of events, a burst event, a user defined event, a lack of a data event, an anomalous event, and/or the like. As discussed, the snapshot metric(s) may be dynamic based on the machine learning 108. The snapshot event(s) 300 are created based on the snapshot metric(s) and/or machine learning 108 in step 602. The snapshot event(s) 300 is then sent to the queue(s) 106 in step 408.

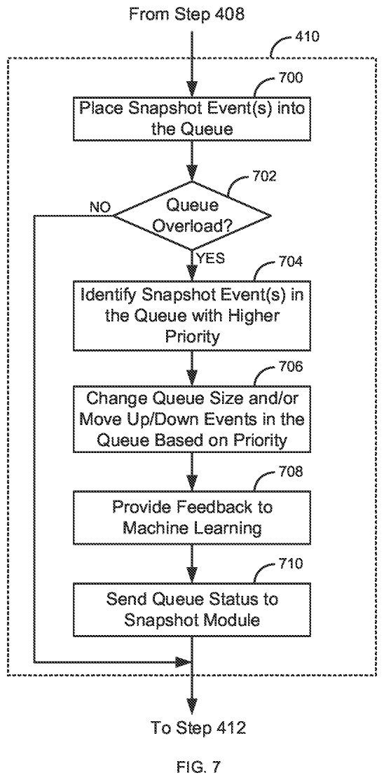

FIG. 7 is a flow diagram of a process for managing an overloaded queue 106. FIG. 7 is an exemplary embodiment of step 410 of FIG. 4. After receiving the snapshot event(s) 300 in step 408, the snapshot event(s) 300 are placed into the queue 106 in step 700. The queue 106 determines, in step 702 if the queue 106 is overloaded. For example, the queue 106 may have one or more thresholds that are used to determine if the queue 106 is overloaded. If the queue 106 is not overloaded in step 702, the process goes to step 412.

Otherwise, if the queue 106 is overloaded in step 702, the queue 106 identifies the snapshot event(s) 300 that are higher priority in step 704. The queue 106 changes the queue size and/or moves the snapshot event(s) 300 up or down based on the priority. In one embodiment, instead of moving the snapshot event(s) 300, the higher priority snapshot event(s) 300 are sent before lower priority snapshot event(s) 300 even if the lower priority snapshot event(s) 300 were placed in the queue 106 at earlier point in time. The queue 106 provides feedback to the machine learning 108 in step 708. For example, the queue 106 may provide feedback that the queue 106 is 80% loaded. The queue 106 sends the queue status (how loaded) to the snapshot module 104 in step 710. This may cause the snapshot module 104 to start changing one or more of the snapshot metrics for one or more types of snapshot events 300. The process then goes to step 412.

In one embodiment, the queue 106 may also send a status to the snapshot module 104 when the queue 106 falls below the threshold. The snapshot module 104 then uses this to adjust the snapshot metrics.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

What is claimed is:

1. A system comprising:
a microprocessor; and
a computer readable medium, coupled with the microprocessor and comprising microprocessor readable and executable instructions that, when executed by the microprocessor, cause the microprocessor to:
receive a snapshot event, wherein the snapshot event is a snapshot of data that was sampled based on a snapshot metric;
determine a destination analytical database for the snapshot event;
send the snapshot event to the destination analytical database; and
store the snapshot event in the destination analytical database.

2. The system of claim 1, wherein the snapshot event is placed into a queue and wherein the queue sends the snapshot event to the destination analytical database.

3. The system of claim 2, wherein the queue comprises a higher priority snapshot event and a lower priority snapshot event and wherein the higher priority snapshot event has priority over the lower priority snapshot event based on a threshold of the queue.

4. The system of claim 2, wherein a size of the queue changes based on a number of snapshot events in the queue.

5. The system of claim 2, wherein the snapshot metric changes based on a threshold of the queue.

6. The system of claim 1, wherein the queue comprises a plurality of queues and wherein the plurality of queues comprise at least one of:
a high priority queue and a low priority queue; and
a plurality of queues that service a plurality of destination analytical databases;

7. The system of claim 1, wherein the snapshot metric is a time period and wherein the snapshot data is an average of data that was sampled during the time period.

8. The system of claim 1, wherein the snapshot metric comprises one or more of a time period, an event, a number of events, a specific series of events, a burst event, a user defined event, a lack of a data event, and an anomalous event.

9. The system of claim 1, wherein the snapshot metric is learned based on a machine learning that groups different events that use a similar snapshot metric and wherein the similar snapshot metric is used for a plurality of snapshot events that are stored in the destination analytical database.

10. The system of claim 1, wherein the snapshot metric dynamically changes based on at least one of: machine learning and a threshold.

11. The system of claim 1, wherein an event filter is used to filter out one or more events and wherein the event filter uses different snapshot templates to filter out the one or more events based one or more types of detected events.

12. A method comprising:
receiving, by a microprocessor, a snapshot event, wherein the snapshot event is a snapshot of data that was sampled based on a snapshot metric;
determining, by the microprocessor, a destination analytical database for the snapshot event;
sending, by the microprocessor, the snapshot event to the destination analytical database; and
storing, by the microprocessor, the snapshot event in the destination analytical database.

13. The method of claim 12, wherein the snapshot event is placed into a queue and wherein the queue sends the snapshot event to the destination analytical database.

14. The method of claim 13, wherein the queue comprises a higher priority snapshot event and a lower priority snapshot event and wherein the higher priority snapshot event has priority over the lower priority snapshot event based on a threshold of the queue.

15. The method of claim 13, wherein a size of the queue changes based on a number of snapshot events in the queue.

16. The method of claim 13, wherein the snapshot metric changes based on a threshold of the queue.

17. The method of claim 12, wherein the queue comprises a plurality of queues and wherein the plurality of queues comprise at least one of:
a high priority queue and a low priority queue; and
a plurality of queues that service a plurality of destination analytical databases;

18. The method of claim 12, wherein the snapshot metric is a time period and wherein the snapshot data is an average of data that was sampled during the time period.

19. The method of claim 12, wherein the snapshot metric comprises one or more of a time period, an event, a number of events, a specific series of events, a burst event, a user defined event, a lack of a data event, and an anomalous event.

20. A non-transient computer readable medium having stored thereon
instructions that cause a processor to execute a method, the method comprising instructions to:
receive a snapshot event, wherein the snapshot event is a snapshot of data that was sampled based on a snapshot metric;
determine a destination analytical database for the snapshot event;
send the snapshot event to the destination analytical database; and
store the snapshot event in the destination analytical database.
